(19) United States
(12) Patent Application Publication
(10) Pub. No.: US 2026/0084950 A1
(43) Pub. Date: Mar. 26, 2026

(54) CONTROL OF A HANDLING MACHINE

(71) Applicant: MANITOU BF, ANCENIS (FR)

(72) Inventor: Julien LE DÛ, ANCENIS (FR)

(21) Appl. No.: 19/328,958

(22) Filed: Sep. 15, 2025

(30) Foreign Application Priority Data
Sep. 25, 2024 (FR) 2410219

(51) Int. Cl. B66F 17/00; B66F 9/065; B66F 9/075

(52) U.S. Cl. CPC B66F 17/003; B66F 9/0655; B66F 9/0755

(57) ABSTRACT

The invention relates to a handling machine (1) comprising sensors (16, 18) configured to measure an extension range of the handling arm and an angle of inclination of the handling arm (6) relative to a horizontal plane or relative to the main body (2) of the handling machine, and a control unit (10) configured to:
determine a cut-off threshold value as a function of the extension range and the angle of inclination of the handling arm (6), such that the cut-off threshold value is an increasing function of an effective distance ( [symbol] ) between the second end of the handling arm (6) and the tilt axis, wherein the effective distance ( [symbol] ) represents a distance projected onto a horizontal axis or onto a longitudinal axis of the main body,
stop a movement of the handling arm in response to a detection that the instability signal is greater than the cut-off threshold value.

### TECHNICAL FIELD

The invention relates to the field of handling machines, in particular a handling machine of the type comprising a main body, a telescopic handling arm mounted on said main body and displaceable in rotation about a horizontal axis of rotation, the axis of rotation being located on a first end of the handling arm and a second end of the handling arm being configured to receive a load to be handled, actuators configured to lift and lower the handling arm about the axis of rotation, and to deploy and retract the handling arm in a longitudinal direction of said handling arm, and a tilt detector configured to produce a signal which is representative of a tilt moment applied to the main body about a tilt axis of said handling machine.

### TECHNOLOGICAL BACKGROUND

For a handling machine of the aforementioned type, the regulations require that the user is provided with a load chart which defines the authorized positions of the handling arm for the various transported masses. The regulations also require stability tests to be carried out by placing the handling machine, together with the transported mass, on an inclined plane, the inclination thereof increasing the instability. During the stability tests, the handling machine has to be stable in all of the positions authorized by the load chart.

The use of an inclined plane has the effect of increasing the tendency of the machine to tilt relative to a use in the horizontal. This is carried out with the purpose of incorporating safety margins in the load chart, which will guarantee that using the machine within the limits of the load chart does not put the user in danger. The increase in the tendency to tilt caused by the inclined plane affects the various elements contributing to the total tilt moment to varying degrees. In particular, as the centre of gravity of the mass transported at the end of the handling arm is greater than the centre of gravity of the handling arm itself, the inclined plane amplifies the contribution of the tilt moment caused by the mass transported at the end of the handling arm to a greater proportion than the contribution of the tilt moment caused by the handling arm itself. In other words, the load chart incorporates safety margins which take account of the two contributions of the tilt moment to varying degrees.

It is known to produce a signal representing the instability of the handling machine by means of a strain gauge placed on the axle opposing the transported mass, i.e. on the rear axle for a machine transporting a load cantilevered to the front. It is known to provide a stability monitoring system configured to compare the signal representing the stability with a cut-off threshold and to interrupt a movement of the handling arm which increases the instability of the machine as soon as the signal representing the stability passes the cut-off threshold. To determine such a cut-off threshold, it is necessary to determine a safety margin relative to the actual stability limit of the machine, in particular due to the response time of the stability monitoring system and inertial forces which can result from the interruption of the movement. These inertial forces have been described, for example, in EP 3431435 A1.

### SUMMARY

The instability signal produced by means of the strain gauge is incapable of making the slightest distinction between the contribution of the tilt moment caused by the mass transported at the end of the handling arm and the contribution of the tilt moment caused by the handling arm itself. The application of a safety margin in the cut-off threshold thus limits the accumulation of the two contributions but cannot limit each thereof separately. This results in a problem of providing a stability monitoring system which guarantees the operational safety of the machine, while permitting movements of the handling arm in all of the positions authorized by the load chart. This problem, in particular, is due to the fact that the load chart takes account of the two contributions of the tilt moment to varying degrees.

In practice, it has been observed that the lower the mass of the load, the greater the contribution of the tilt moment caused by the handling arm is overrepresented in the instability signal, relative to the contribution actually taken into account in the stability tests, which causes an interruption to the movement by the stability monitoring system increasingly further away from the limits stored in the load chart, and thus an impaired performance.

One idea forming the basis of this invention consists in providing a handling machine authorizing a greater range of use of the handling arm without risking the tilting of the machine. A further idea forming the basis of the invention is that the mass of the load can be taken into account without being expressly measured, by combining the instability signal with a measurement of the effective distance of the cantilever of the load.

In order to achieve this, the invention proposes a handling machine of the aforementioned type, further comprising:
sensors configured to measure an extension range of the handling arm and an angle of inclination of the handling arm relative to a horizontal plane or relative to the main body of the handling machine, and
a control unit configured to:
determine a cut-off threshold value as a function of the extension range and the angle of inclination of the handling arm, such that the cut-off threshold value becomes less restrictive when an effective distance between the second end of the handling arm and the tilt axis increases, wherein the effective distance represents a distance projected onto a horizontal axis or onto a longitudinal axis of the main body,
stop a movement of the handling arm in response to a detection that the signal which is representative of the tilt moment has passed the cut-off threshold value.

Due to these features, the instability signal is treated differently according to the effective cantilever distance to which it corresponds. This makes it possible to take into account the mass of the load, which is lower—all things being equal—the greater the effective distance. In other words, this makes it possible to minimize the effect of the mass of the handling arm. The use of an increasing cut-off threshold, which is thus more generous, when the effective distance increases, thus makes it possible to compensate for the over-representation of the contribution of the tilt moment caused by the handling arm when the mass of the load is small.

According to a further aspect of the invention, a control method for a handling machine is proposed, comprising a main body, a telescopic handling arm mounted on said main body and displaceable in rotation about a horizontal axis of rotation, the axis of rotation being located on a first end of the handling arm and a second end of the handling arm being configured to receive a load to be handled, and actuators configured to lift and lower the handling arm about the axis of rotation, and to deploy and retract the handling arm in a longitudinal direction of said handling arm, said method comprising:
receiving from a tilt detector, an instability signal which is representative of a tilt moment applied to the main body about a tilt axis of said handling machine,
receiving, from sensors, measuring signals representing an extension range of the handling arm and an angle of inclination of the handling arm relative to a horizontal plane or relative to the main body of the handling machine,
determining a cut-off threshold value as a function of the extension range and the angle of inclination of the handling arm, such that the cut-off threshold value becomes less restrictive when an effective distance between the second end of the handling arm and the tilt axis increases, wherein the effective distance represents a distance projected onto a horizontal axis or onto a longitudinal axis of the main body,
stopping a movement of the handling arm in response to a detection that the signal which is representative of the tilt moment has passed a cut-off threshold value.

The control method can be executed by a control unit encompassed by the handling machine.

According to advantageous embodiments, such a machine or such a method can have one or more of the following features.

According to one embodiment, the signal which is representative of the tilt moment is an instability signal and the cut-off threshold value is an increasing function of the effective distance between the second end of the handling arm and the tilt axis, the movement of the handling arm being stopped in response to a detection that the instability signal is greater than a cut-off threshold value.

“Increasing function” is understood to mean a function which is not constant over its entire range of definition and which does not decrease. The increasing function can be strictly increasing. The increasing function can be constant over the value ranges of the effective distance. The increasing function can include stepped portions on the value ranges of the effective distance and/or strictly increasing portions on the value ranges of the effective distance, in particular linear portions on the value ranges of the effective distance.

According to one embodiment, the cut-off threshold value has at least one first value when the effective distance is in a first value range less than a predetermined distance and at least one second value greater than the first value when the effective distance is in a second value range greater than a predetermined distance. In one embodiment, the cut-off threshold value adopts further values when the effective distance is outside the first and second value ranges.

The tilt sensor can be implemented in different ways. According to one embodiment, the main body is mounted on wheels borne by axles, the axis of rotation being transverse to the main body and the tilt detector comprises an extensometer arranged in the region of an axle opposing the second end of the handling arm.

The actuators of the handling machine can be implemented in different ways. According to one embodiment, the actuators comprise a lifting actuator, for example of the hydraulic or electric type, connected on the one hand to the handling arm and on the other hand to the main body and configured to displace the handling arm in rotation about the axis of rotation in order to carry out upward and downward movements.

According to one embodiment, the handling arm comprises a plurality of segments which can be deployed and the actuators comprise one or more extension actuators, for example of the hydraulic type, each extension actuator being arranged between two or more segments configured to deploy or retract the handling arm.

The sensors can be implemented in numerous ways. According to one embodiment, the sensors comprise an angle sensor configured to measure an angle of inclination of the handling arm relative to a horizontal plane or relative to the main body of the handling machine. The angle sensor can be arranged in the region of the axis of rotation. The angle sensor can be an inclinometer.

Alternatively, the angle sensor can be a sensor arranged on a mobile part coupled to the handling arm. Such a sensor can be configured to determine an actuating travel of the lifting actuator.

According to a further example, the sensors comprise a first inclinometer arranged on the main body and a second inclinometer arranged on the handling arm. The angle of inclination of the handling arm relative to the main body is thus obtained by the difference between the measurements of the two inclinometers.

According to one embodiment, the sensors comprise a length sensor configured to measure an extension range of the handling arm. The length sensor can be arranged on one or more segments of the handling arm and configured to measure a distance between the segment(s) relative to the main body.

Alternatively, the length sensor can be a sensor arranged on a mobile part coupled to the handling arm. Such a sensor can be configured to determine an actuating travel of the extension actuator(s).

According to one embodiment, the handling machine further comprises a request member which can be actuated by an operator to generate a movement request signal, the control unit being configured to cause the movement of the handling arm in response to the movement request signal.

The movement request signal can be produced in different ways. According to one embodiment, the movement request detectors can be implemented by one or more sensors provided on a lever or a control knob, this sensor or these sensors being able to be, in a non-limiting manner, commutators, potentiometers or Hall effect sensors connected to the control unit. In particular, the control unit can be configured to determine a signal originating from said request member corresponding to a movement to be carried out by said handling machine, for example a lowering, lifting, extending and retracting movement of the handling arm.

According to one embodiment, a signalling means is arranged in the handling machine and is configured to display or output a warning signal if the instability signal is close to the cut-off threshold or greater than the cut-off threshold. The warning signal can be audible and/or visual. The signalling means can be a display arranged in a cab of the handling machine provided for a user of the handling machine. Alternatively or in addition, the signalling means can be an alarm arranged in the cab and configured to output the warning signal.

In particular, the control unit is configured to monitor the signalling means in order to display or output the warning signal.

The cut-off threshold values can be stored in different ways. According to one embodiment, the cut-off threshold values and the corresponding effective distances are predetermined, in particular, as a function of the geometry of the handling arm and the main body and previously stored in an on-board memory of the handling machine. According to one embodiment, the cut-off threshold values can be stored in the form of correction coefficients dependant on the effective distances and having to be multiplied to a nominal threshold value.

According to one embodiment, the handling machine comprises a plurality of stabilizing feet configured to be deployed or retracted from the main body, and the cut-off threshold values vary as a function of the deployment or non-deployment of said stabilizing feet. According to one embodiment, it is the correction coefficients which vary as a function of the deployment or non-deployment of said stabilizing feet.

Such a handling machine can be implemented,, in particular, in the form of a forklift truck with a telescopic arm.

### BRIEF DESCRIPTION OF THE FIGURES

The invention will be more clearly understood and further objects, details, features and advantages thereof will appear more clearly during the course of the following description of several particular embodiments of the invention, provided solely in an illustrative and non-limiting manner, with reference to the accompanying drawings.

FIG. 1 is a schematic view of a handling machine.

FIG. 2 is a view of a tilt detector able to be used in the handling machine of FIG. 1.

FIG. 3 is a schematic view of a calibration curve able to be used in the handling machine of FIG. 1.

FIG. 4 is a graphical representation of cut-off threshold values able to be used in the handling machine of FIG. 1 according to a first example.

FIG. 5 is a schematic view of a control method able to be used by the handling machine of FIG. 1.

FIG. 6 is a graphical representation of cut-off threshold values able to be used in the handling machine of FIG. 1 according to a second example.

### DESCRIPTION OF EMBODIMENTS

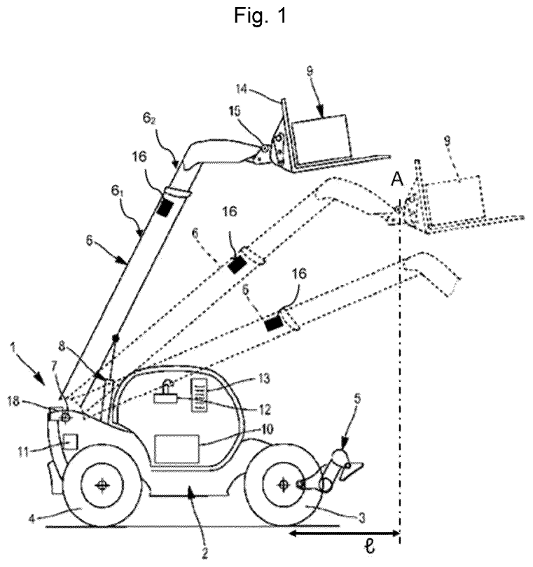

A handling machine 1, which in this case is a forklift truck with a telescopic arm, is shown in FIG. 1. The handling machine 1 comprises a frame 2 supported on the ground by means of a front axle bearing front wheels 3 and a rear axle 4 bearing rear wheels. The handling machine 1 comprises a handling arm 6 of the telescopic type mounted on the frame 2 by a first end and able to be oriented about a transverse axis of rotation 7 relative to the frame 2. The handling arm 6 comprises a load carrying implement 14 articulated at a second end of the handling arm 6 by the connection 15 and configured to bear a payload 9. In the example shown, the load carrying implement 14 is a fork, but other implements can be used, for example a bucket.

The handling arm 6 is displaceable in rotation by a cylinder 8 connected to the frame 2 and to the handling arm 6. The handling arm 6 comprises at least two segments 6₁ and 6₂ which can be deployed using an extension cylinder, not shown, arranged between the at least two segments 6₁ and 6₂.

A further actuator, not shown, is arranged to modify the orientation of the load carrying implement 14 about a transverse axis of rotation relative to the frame 2.

The handling machine 1 also comprises an actuation request member 12 configured to control manually the handling arm 6, making it possible to lift and lower and to deploy and retract the handling arm 6.

The handling machine 1 also comprises position detectors configured to produce a signal relative to a position of the handling arm 6, in particular an angle of inclination of the handling arm 6 relative to the frame 2 and an extension length of the handling arm 6.

The position detectors comprise, for example, a first sensor 18 located in the region of the axis 7 and arranged to measure the angle of inclination of the handling arm 6. The first sensor 18 produces a signal which is representative of the angle of inclination of the handling arm 6 relative to the frame 2. The position detectors comprise, for example, a second sensor 16 located in the region of the extension cylinder and arranged to measure a travel of the extension cylinder. The second sensor 16 produces a signal which is representative of the extension length of the handling arm 6.

FIG. 1 shows the handling arm 6 bearing the payload 9 in an upper and retracted position in solid lines and in a plurality of lower and further deployed positions in dashed lines. The static tilt moment exerted by the handling arm 6 and the payload 9 in the forward direction increases as the cantilever increases, since its position is lowered toward the horizontal and/or since the length of the handling arm 6 increases.

The position detectors permit the control unit 10 to determine a measurement of the cantilever in the form of an effective distance between the tilt axis of the machine and the second end of the handling arm bearing the load. This effective distance could be defined in different ways. In the example shown, it is the distance [symbol] between the base of the front wheel 3 and the projection onto the ground of a reference point A selected on the handling arm 6. In the example shown, the reference point A corresponds to the connection 15 but other choices are possible.

The handling machine 1 also comprises a tilt detector 11 configured to produce a signal which is representative of a tilt moment applied to the frame 2 about a tilt axis, located in this case in the region of the front axle 3. Stabilizing feet 5 can be optionally deployed to raise the front axle, in which case the stabilizing feet 5 define the tilt axis.

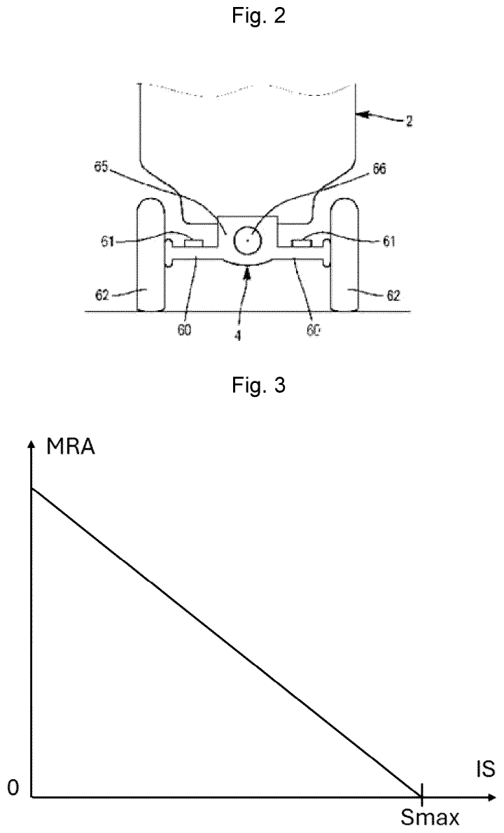

In one embodiment, shown in FIG. 2, the tilt detector 11 is arranged in the region of the rear axle 4.

In FIG. 2, the rear axle 4 of the handling machine 1 comprises two wheel support arms 60 bearing rear wheels 62. Each wheel support arm 60 comprises an extensometer 61, for example in the form of a strain gauge, configured to measure an elastic deformation of the wheel support arm 60, for example a bending deformation of the wheel support arm 60, in particular a variation in length between two markers spaced apart on the wheel support arm 60. The measuring signals of the extensometers 61 can be used to form the signal which is representative of the tilt moment, for example as an average of the two measuring signals. Alternatively, it is possible to use a single extensometer 61 to produce the signal which is representative of the tilt moment. Preferably, the rear axle 4 is connected in an oscillating manner to the frame 2 by means of a pivot 66 having a longitudinal axis passing through a central part 65 of the axle.

FIG. 3 illustrates a calibration curve to calibrate the signal which is representative of the tilt moment, in the form of an instability signal IS which increases when the machine approaches a situation of tilting longitudinally to the front and which reduces when it moves away therefrom.

The residual mass at the rear MRA, which is the mass which would be weighed by weighing scales placed below the rear wheels 62, is shown on the Y-axis. Subject to linearity errors of the extensometers 61, the measuring signals of the extensometers 61 vary linearly with MRA.

The instability signal IS has been shown on the X-axis. It is possible to calibrate the instability signal IS with two measuring points.

For the first measuring point, a standardized load is placed on the load carrying implement 14 and the handling arm 6 is placed in a fully lowered and retracted position. The handling machine 1 is in a very stable state corresponding to a specific positive value of MRA. Thus the value 0 is applied to the instability signal IS.

For the second measuring point, the handling arm 6 is placed in a sufficiently extended position that the handling machine 1 tilts longitudinally to the front. The rear axle 4 no longer touches the ground. Thus a positive value Smax is applied to the instability signal IS, which corresponds to a zero value of MRA. Between the two measuring points, a linear law is applied to generate the instability signal IS from the measuring signals of the extensometers 61.

The second measuring point is never a physical extreme of the handling machine 1. It is sufficient that it corresponds to a very stable state. In other words, it is possible that the instability signal IS reaches negative values during the use of the machine.

The handling machine 1 also comprises a control unit 10 which is configured to receive signals from the tilt detector 11 and stop the movement of the handling arm 6 if the instability signal is greater than a cut-off threshold value. For example, the control unit 10 is configured to prevent or stop the movement of the handling arm 6 by stopping the hydraulic flow for supplying the cylinder 8 and/or the extension cylinder.

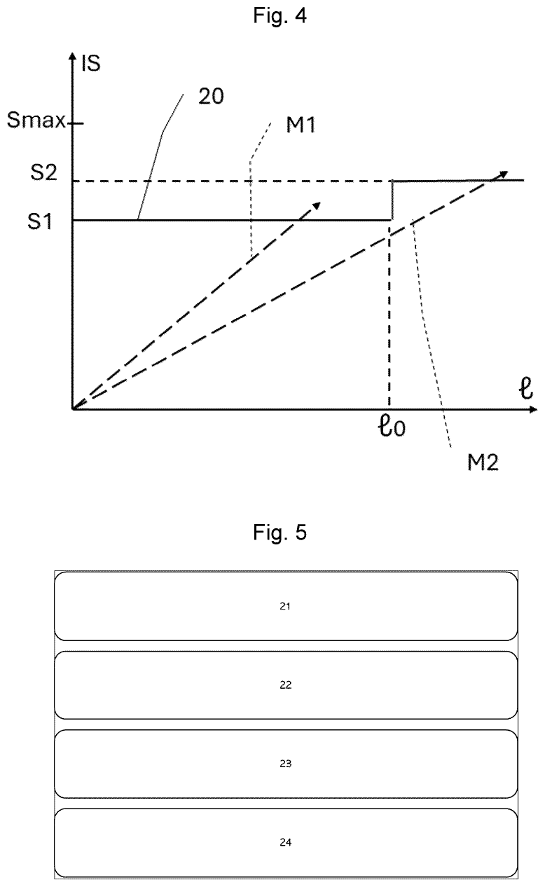

A first example of the increasing relation between the cut-off threshold value and the distance [symbol] which can be used by the control unit 10 has been shown with reference to FIG. 4. The curve 20 represents the cut-off threshold value. For a distance [symbol] less than a predetermined positive value [symbol] 0, the cut-off threshold value adopts a first value S1. For a distance [symbol] greater than the predetermined positive value [symbol] 0, the cut-off threshold value adopts a second value S2 greater than S1.

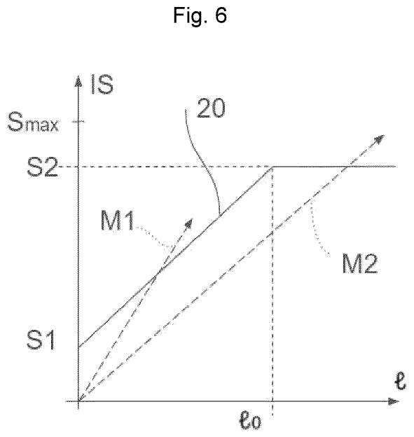

FIG. 6 shows a second example using the same reference signs as FIG. 4. In this case, the cut-off threshold value increases linearly from the first value S1 to the second value S2 when the distance [symbol] increases from 0 to the predetermined positive value [symbol] 0.

### Numerical Example

In one example, the value 130 is applied to Smax, the value 105 is applied to S1 and the value 110 is applied to S2 (arbitrary unit).

For a machine of which the total mass is approximately 12 t and the lifting height is greater than 17 m, the predetermined positive value [symbol] 0 is greater than 7 m for operation on wheels and greater than 8 m for operation on stabilizers.

The arrows M1 and M2 illustrate qualitatively the operation of the stability monitoring system used by the control unit 10 during the handling of two different loads. Given that the Y-axis represents the tilt moment (via the instability signal IS) and the X-axis represents the cantilever (via the distance [symbol] ) the gradient of the arrow M1 or M2 changes qualitatively as the mass of the load. The arrow M1 thus corresponds to a heavier mass than the arrow M2.

The arrows M1 and M2 illustrate a handling operation which tends to increase the cantilever until the control unit 10 interrupts the movement of the handling arm 6 when the instability signal IS passes the cut-off threshold value. For a heavier mass, it is the threshold value S1 which is reached by the arrow M1. For the lighter mass, however, it is the threshold value S2 which is reached by the arrow M2. The stability monitoring system is thus less restrictive for handling a lighter load, in the sense that it makes it possible to reach positions nearer to the tilt situation (implemented by the value Smax) than for a heavier load.

In the example of FIGS. 2 to 4 and 6, the signal which is representative of the tilt moment is an instability signal IS which increases when the machine approaches a situation of tilting longitudinally toward the front. Other choices are possible. For example, if one uses a signal which is representative of the tilt moment which varies as MRA, namely which reduces when the machine approaches a situation of tilting longitudinally toward the front, the relations between the different threshold values have to be reversed relative to those which have been described for the instability signal IS.

The handling machine 1 comprises a display 13 which is connected to the control unit 10 and configured to display a warning signal if the instability signal is close to or greater than the cut-off threshold value.

In all cases, the control unit 10 can be configured to implement a control method as shown in FIG. 5.

The control method serves to stop the movement of the handling arm 6 in order to avoid a tilting of the handling machine 1.

The method comprises:
a step 21 of determining the distance [symbol] ,
a step 22 of determining the cut-off threshold value as a function of the distance [symbol] ,
a step 23 of comparing the signal which is representative of the tilt moment with the cut-off threshold value,
a step 24 of stopping or preventing the movement of the handling arm 6 when the signal relative to the tilt moment has passed the cut-off threshold value.

This method is executed, for example, iteratively at a certain clock rate according to the known technique.

According to one embodiment, the cut-off threshold value is preferably variable as a function of the deployment or non-deployment of the stabilizing feet 5.

According to one embodiment, the stoppage of the movement is preceded by a controlled deceleration by the control unit 10, for example according to the principles taught in JP 3252006.

Some elements which are shown, in particular the control unit, can be implemented in different forms in a unitary or apportioned manner by means of hardware and/or software components. The usable hardware components are ASIC specific integrated circuits, FPGA programmable logic arrays or microprocessors. Software components can be written in different programming languages, for example C, C++, Java or VHDL. This list is not exhaustive.

While the invention might have been described in connection with several particular embodiments, it is obvious that it is not limited in any way and that it comprises all technical equivalents of the means described and the combinations thereof if they fall within the scope of the invention.

The use of the verb “contain”, “comprise” or “include” and its conjugated forms does not exclude the presence of other elements or other steps from those mentioned in a claim.

In the claims, any reference sign in parenthesis should not be interpreted as a limitation of the claim.

1. Handling machine (1) comprising:
a main body (2),
a telescopic handling arm (6) mounted on said main body and displaceable in rotation about a horizontal axis of rotation (7), the axis of rotation being located on a first end of the handling arm (6) and a second end of the handling arm (6) being configured to receive a load to be handled, actuators (8) configured to lift and lower the handling arm about the axis of rotation, and to deploy and retract the handling arm in a longitudinal direction of said handling arm,
a tilt sensor (11) configured to produce a signal which is representative of a tilt moment applied to the main body about a tilt axis of said handling machine,
sensors (18, 16) configured to measure an extension range of the handling arm and an angle of inclination of the handling arm (6) relative to a horizontal plane or relative to the main body (2) of the handling machine, and a control unit (10) configured to:
determine a cut-off threshold value as a function of the extension range and the angle of inclination of the handling arm (6), such that the cut-off threshold value (S1, S2) becomes less restrictive when an effective distance between the second end of the handling arm (6) and the tilt axis increases, wherein the effective distance ( [symbol] ) represents a distance projected onto a horizontal axis or onto a longitudinal axis of the main body,
stop (24) a movement of the handling arm in response to a detection that the signal which is representative of the tilt moment has passed the cut-off threshold value.

2. Machine according to claim 1, wherein the signal which is representative of the tilt moment is an instability signal (IS) and wherein the cut-off threshold value (S1, S2) is an increasing function of the effective distance ( [symbol] ) between the second end of the handling arm (6) and the tilt axis, the movement of the handling arm being stopped in response to a detection that the instability signal (IS) is greater than a cut-off threshold value.

3. Machine according to claim 1 or 2, wherein the cut-off threshold value has at least one first value (S1) when the effective distance is in a first value range less than a predetermined distance and at least one second value (S2) greater than the first value when the effective distance is in a second value range greater than the predetermined distance.

4. Machine according to any one of claims 1 to 3, wherein the main body (2) is mounted on wheels borne by axles, the axis of rotation (7) being transverse to the main body and the tilt sensor comprises an extensometer (61) arranged in the region of an axle (4) opposing the second end of the handling arm (6).

5. Machine according to any one of claims 1 to 4, also comprising a request member (12) which can be actuated by an operator to generate a movement request signal, the control unit (10) being configured to cause the movement of the handling arm in response to the movement request signal.

6. Control method for a handling machine (1) comprising a main body (2), a telescopic handling arm (6) mounted on said main body and displaceable in rotation about a horizontal axis of rotation (7), the axis of rotation being located on a first end of the handling arm (6) and a second end of the handling arm (6) being configured to receive a load to be handled, and actuators (8) configured to lift and lower the handling arm about the axis of rotation, and to deploy and retract the handling arm in a longitudinal direction of said handling arm, said method comprising:
receiving from a tilt detector (11) a signal which is representative of a tilt moment (IS) applied to the main body about a tilt axis of said handling machine,
receiving, from sensors (16, 18), measuring signals representing an extension range of the handling arm and an angle of inclination of the handling arm (6) relative to a horizontal plane or relative to the main body (2) of the handling machine,
determining a cut-off threshold value as a function of the extension range and the angle of inclination of the handling arm (6), such that the cut-off threshold value (S1, S2) becomes less restrictive when an effective distance between the second end of the handling arm (6) and the tilt axis increases, wherein the effective distance ( [symbol] ) represents a distance projected onto a horizontal axis or onto a longitudinal axis of the main body,
stopping (24) a movement of the handling arm in response to a detection that the signal which is representative of the tilt moment (IS) has passed the cut-off threshold value.

7. Method according to claim 6, wherein the signal which is representative of a tilt moment is an instability signal (IS) and wherein the cut-off threshold value is an increasing function of the effective distance between the second end of the handling arm (6) and the tilt axis, the movement of the handling arm being stopped in response to a detection that the instability signal (IS) is greater than the cut-off threshold value.
